(19) United States
(12) Patent Application Publication
(10) Pub. No.: US 2025/0347818 A1
(43) Pub. Date: Nov. 13, 2025

(54) SEISMIC IMAGING FRAMEWORK

(71) Applicant: Schlumberger Technology Corporation, Sugar Land, TX (US)

(72) Inventors: Gustavo Adolfo Hernandez Mayes, Villahermosa (MX); William Sanger, Houston, TX (US)

(21) Appl. No.: 19/205,484

(22) Filed: May 12, 2025

Related U.S. Application Data
(60) Provisional application No. 63/646,204, filed on May 13, 2024.

(51) Int. Cl. G01V 1/50

(52) U.S. Cl. CPC G01V 1/50; G01V 2210/584; G01V 2210/74

(57) ABSTRACT

A method can include defining an input domain for each of multiple tasks of a seismic imaging workflow to define multiple input domains for seismic data; generating multiple samples from the input domain for each of the multiple tasks; clustering the multiple samples from the multiple input domains to generate input domain clusters; assigning a number of the input domain clusters to each of the multiple tasks, where one or more of the input domain clusters are shared by more than one of the multiple tasks; clustering the multiple tasks, based on a sharing network of the input domain clusters, to generate clusters of the multiple tasks; and ordering the clusters of the multiple tasks to generate an order.

### RELATED APPLICATION

This application claims priority to and the benefit of a US Provisional Application having Ser. No. 63/646,204, filed 13 May 2024, which is incorporated by reference herein in its entirety.

### BACKGROUND

Reflection seismology finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks.

### SUMMARY

A method can include defining an input domain for each of multiple tasks of a seismic imaging workflow to define multiple input domains for seismic data; generating multiple samples from the input domain for each of the multiple tasks; clustering the multiple samples from the multiple input domains to generate input domain clusters; assigning a number of the input domain clusters to each of the multiple tasks, where one or more of the input domain clusters are shared by more than one of the multiple tasks; clustering the multiple tasks, based on a sharing network of the input domain clusters, to generate clusters of the multiple tasks; and ordering the clusters of the multiple tasks to generate an order. A system can include a processor; memory operatively coupled to the processor; and processor-executable instructions stored in the memory to instruct the system to: define an input domain for each of multiple tasks of a seismic imaging workflow to define multiple input domains for seismic data; generate multiple samples from the input domain for each of the multiple tasks; cluster the multiple samples from the multiple input domains to generate input domain clusters; assign a number of the input domain clusters to each of the multiple tasks, where one or more of the input domain clusters are shared by more than one of the multiple tasks; cluster the multiple tasks, based on a sharing network of the input domain clusters, to generate clusters of the multiple tasks; and order the clusters of the multiple tasks to generate an order. One or more computer-readable storage media can include processor-executable instructions to instruct a computing system to: define an input domain for each of multiple tasks of a seismic imaging workflow to define multiple input domains for seismic data; generate multiple samples from the input domain for each of the multiple tasks; cluster the multiple samples from the multiple input domains to generate input domain clusters; assign a number of the input domain clusters to each of the multiple tasks, where one or more of the input domain clusters are shared by more than one of the multiple tasks; cluster the multiple tasks, based on a sharing network of the input domain clusters, to generate clusters of the multiple tasks; and order the clusters of the multiple tasks to generate an order. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a geologic environment and an example of a technique;

FIG. 2 illustrates examples of techniques for seismic data;

FIG. 3 illustrates examples of geologic environments and examples of equipment;

FIG. 4 illustrates examples of geologic environments, examples of equipment and examples of acquisition methods;

FIG. 5 illustrates an example of a seismic volume and an example of a slice;

FIG. 6 illustrates an example of a source and a receiver pair;

FIG. 7 illustrates an example of a technique;

FIG. 8 illustrates an example of a technique;

FIG. 9 illustrates an example of a technique;

FIG. 10 illustrates an example of a technique;

FIG. 11 illustrates examples of areas;

FIG. 12 illustrates examples of areas;

FIG. 13 illustrates an example of a technique;

FIG. 14 illustrates an example of a technique;

FIG. 15 illustrates an example of a scenario and an associated method;

FIG. 16 illustrates example graphics of data re-use;

FIG. 17 illustrates examples of graphics associated with clustering;

FIG. 18 illustrates an example of a method;

FIG. 19 illustrates an example of a method;

FIG. 20 illustrates an example of a framework;

FIG. 21 illustrates an example of a method; and

FIG. 22 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

As mentioned, reflection seismology finds use in geophysics, for example, to estimate properties of subsurface formations. As an example, reflection seismology may provide seismic data representing waves of elastic energy (e.g., as transmitted by P-waves and S-waves, in a frequency range of approximately 1 hertz (Hz) to approximately 100 Hz). Seismic data may be processed and interpreted, for example, to understand better composition, fluid content, extent and geometry of subsurface rocks. As such, seismic data includes information that can characterize a subsurface environment. Further, seismic data may be utilized in one or more control schemes, for example, to control field equipment. For example, consider control of a rig equipment, which may include downhole equipment. In such an example, control of field equipment may aim to direct a drill bit to drill a borehole in a reservoir where such control may aim to increase reservoir contact between the borehole and the reservoir by steering the drill bit according to interfaces or boundaries that may be indicated in seismic data.

As an example, a seismic imaging system can be utilized to perform seismic surveys. For example, consider a land-based survey of a subsurface region where sensors can be positioned according to a survey footprint that may cover an area of square kilometers where one or more seismic energy sources are fired to emit energy that can travel through the subsurface region such that at least a portion of the emitted energy can be received at one or more of the sensors.

As an example, a land-based survey can include an array of sensors for performing a seismic survey where emission vehicles can emit seismic energy to be sensed by the array of sensors where data can be collected by a receiver vehicle as operatively coupled to the array of sensors. In such an example, sensors may be deployed by an individual as that individual walks along paths, which may be, for example, inline or crossline paths associated with a seismic survey. For example, the individual may carry a rod where hooks may allow for looping a cable and where the hooks may be slide off an end of the rod as the individual positions the individual sensors. Individual sensors may, depending on environment, include spikes that can be inserted into the ground (e.g., spikes may be of a length of the order of about 10 cm and be capable of conducting seismic energy to circuitry of the individual sensors). As an example, a sensor may be a UNIQ sensor (SLB, Houston, Texas) or another type of sensor. As an example, a sensor can include an accelerometer or accelerometers. As an example, a sensor may be a geophone. As an example, a sensor may include circuitry for 1C acceleration measurement. As an example, a sensor may be self-testing and/or self-calibrating. As an example, a sensor can include memory, for example, to perform data buffering and optionally retransmission. As an example, a sensor can include short circuit isolation circuitry, open circuit protection circuitry and earth-leakage detection and/or isolation circuitry. In various instances, sensors may be subject to environmental conditions such as lightening where circuitry may help to protect sensors from damage.

As an example, a sensor may include location circuitry (e.g., GPS, etc.). As an example, a sensor can include temperature measurement circuitry. As an example, a sensor can include humidity measurement circuitry. As an example, a sensor can include circuitry for automated re-routing of data and/or power (e.g., as to supply, connection, etc.). As an example, an array of sensors may be networked where network topology may be controllable, for example, to account for one or more damaged and/or otherwise inoperative sensors, etc.

As mentioned, sensors may be cabled to form a sensor string. As an example, consider a string of about 10 sensors where a lead-in length is about 7 meters, a mid-section length is about 14 meters (m) and a weight is about 15 kilograms (kg). As another example, consider a string of about 5 sensors where a lead-in length is about 15 meters and a mid-section length is about 30 meters and a weight is about 12 kg. Such examples may be utilized to understand dimensions of an array of sensors and, for example, how far a sensor is from one or more neighbors, to which it may be operatively coupled (e.g., via one or more conductors, conductive materials, etc.).

As an example, data may be stored in association with one or more types of metadata, which may include metadata as to specifics of a sensor or sensors, an arrangement of sensors, operational status of a sensor or sensors, etc. As an example, such metadata may be utilized for one or more purposes, which may include determination of a loading order for loading of stored data (e.g., for rendering, etc.). For example, a region that may have been subjected to a lightning strike may be indicated via metadata and/or analysis of acquired data where data for such a region may be ordered with respect to other data for purposes of loading (e.g., assessing lightning effected data prior to loading other data, not loading lightning effected data, etc.).

As to a power insertion unit (PIU), such a unit can be utilized for power and/or data routing. For example, such a unit may provide power for a few sensors to tens of sensors to hundreds of sensors (e.g., consider a PIU that can power 500 or more sensors).

As an example, an installation can include a fiber-optic exchanger unit (FOX). For example, such a unit may be a router that can communicate with a PIU. As an example, fiber optic cables may be included in an installation. For example, consider FOX and PIU fiber optic couplings.

As an example, an installation may include over a thousand sensors. As an example, an installation may include tens of thousands of sensors. As an example, an installation may include over one hundred thousand sensors.

As explained, survey acquisition equipment, whether land-based and/or marine-based, can include various types of equipment that are operatively coupled. As an example, noise may originate in one or more manners as to such equipment (e.g., consider lightning strike noise, shark bite noise, wake noise, earthquake noise, etc.).

As to a marine survey, it may involve towing one or more streamers behind a vessel where a streamer includes sensors where one or more seismic energy sources are fired to emit energy that can travel through water and a subsurface region such that at least a portion of the emitted energy can be received at one or more of the sensors. Some types of marine surveys may include equipment that is to be placed on the ocean bottom. For example, consider ocean-bottom cables (OBCs) and ocean-bottom nodes (OBNs). As explained with respect to the land-based equipment, various types of equipment can be utilized to power, acquire, process seismic data. As an example, marine-based equipment may include at least some features of such equipment.

As an example, in marine-based equipment can include sensors where each of the sensors may include at least one geophone and a hydrophone. A geophone may be a sensor configured for seismic acquisition, whether onshore and/or offshore, that can detect velocity produced by seismic waves and that can transform motion into electrical impulses. A geophone may be configured to detect motion in a single direction. A geophone may be configured to detect motion in a vertical direction. Three mutually orthogonal geophones may be used in combination to collect so-called 3C seismic data. A hydrophone may be a sensor configured for use in detecting seismic energy in the form of pressure changes under water during marine seismic acquisition. Hydrophones may be positioned along a string or strings to form a streamer or streamers that may be towed by a seismic vessel (or deployed in a bore).

A surface marine cable may be or include a buoyant assembly of electrical wires that connect sensors and that can relay seismic data to the recording seismic vessel. A multi-streamer vessel may tow more than one streamer cable to increase the amount of data acquired in one pass. A marine seismic vessel may be about 75 m long and travel about 5 knots per hour while towing arrays of air guns and streamers containing sensors, which may be located about a few meters below the surface of the water. A so-called tail buoy may assist crew in location an end of a streamer. An air gun may be activated periodically, such as about each 25 m (e.g., about at 10 second intervals) where the resulting sound wave travels into the Earth, which may be reflected back by one or more rock layers to sensors on a streamer, which may then be relayed as signals (e.g., data, information, etc.) to equipment on the tow vessel.

As to streamers, noise may occur due to vessel factors such as vessel speed, variation in speed, acceleration, waves impacting vessel performance, navigating around icebergs, making turns, etc. For example, where a vessel is to trace a path for a survey, the path can include turns that cause streamers to change in shape, which may cause bending, etc., changes in angles with respect to source originated seismic energy, etc. As vessel operations involves energy expenditure (e.g., liquid fuel, solar power, etc.), a survey may continue during turns of a survey path. As an example, a streamer may experience noise due to jetsam and/or flotsam, which may physically impact a streamer. As an example, a streamer may experience noise due to marine life such as, for example, noise due to a shark bite.

Streamer cables may be spooled onto drums for storage on a vessel, which subjects the streamer cables to various contact and bending forces, etc. (consider winding and unwinding operations).

Seismic data can be spatially two-dimensional or three-dimensional. Seismic data can be taken at different times, such as, for example, a pre-production time and a post-production time where differences can discern effects of production on a geologic region. In some examples, 3D seismic data can be 2D in space and 1D in time and 4D seismic data can be 3D in space and 1D in time; noting that in either instance, seismic signals are acquired with respect to time during a seismic survey (e.g., as may be sampled by seismic acquisition equipment to generate digital seismic data). Seismic data that are 2D spatially can be referred to as a slice (e.g., a 2D slice); while, seismic data that are 3D spatially can be referred to as a cube (e.g., volumetric seismic data).

As to seismic acquisition geometry of a seismic survey, a 2D grid can be considered to be dense where line spacing is less than about 400 m. As to 3D acquisition of seismic data, such an approach may be utilized to uncover (e.g., via interpretation) true structural dip (2D may give apparent dip), enhanced stratigraphic information, a map view of reservoir properties, enhanced areal mapping of fault patterns and connections and delineation of reservoir blocks, and enhanced lateral resolution (e.g., 2D may exhibit detrimental cross-line smearing or Fresnel zone issues).

A 3D seismic dataset can be referred to as a cube or volume of data while a 2D seismic data set can be referred to as a panel of data. To interpret 3D data, processing can be on the “interior” of the cube, which tends to be an intensive computation process because massive amounts of data are involved. For example, a 3D dataset can range in size from a few tens of megabytes to several gigabytes or more.

A 3D seismic data volume can include a vertical axis that is two-way traveltime (TWT) (e.g., a temporal dimension) rather than depth (e.g., a spatial dimension) and can include data values that are seismic amplitude values. Such data may be defined at least in part with respect to a time axis where a trace may be a data vector of values with respect to time.

Acquired field data may be formatted according to one or more formats. For example, consider a well data format AAPG-B, log curve formats LAS or LIS-II, seismic trace data format SEGY, shotpoint locations data formats SEGP1 or UKOOA and wellsite data format WITS.

As to SEGY, which may be referred to as SEG-Y or SEG Y, it is a file format developed by the Society of Exploration Geophysicists (SEG) for storing geophysical data. It is an open standard, and is controlled by the SEG Technical Standards Committee, a non-profit organization. The format was originally developed in 1973 to store single-line seismic reflection digital data on magnetic tapes. The most recent revision of the SEG-Y format was published in 2017, named the rev 2.0 specification and includes certain legacies of the original format (referred as rev 0), such as an optional SEG-Y tape label, the main 3200-byte textual EBCDIC character encoded tape header and a 400-byte binary header.

A format referred to as ZGY (or zgy) is a file format that can be used for storing 3D seismic trace data. Data may be converted to ZGY from SEG-Y format. The ZGY format supports compression of data. ZGY uses bricking to store multiple resolutions of a dataset. As an example, a brick may include 64×64×64 samples, though brick sizes can vary. ZGY can be a compressed format of the SEG-Y data such that the ZGY format demands less storage space, where ZGY format data may be readily exchangeable.

The AAPG Computer Applications Committee has proposed the AAPG-B data exchange format for general purpose data transfers among computer systems, applications software, and companies. For log curves, the SLB LIS (log information standard) has become a de facto standard, and extensions to it have been proposed. Another log data format called LAS, for log ASCII standard, has been proposed by the Canadian Well Logging Society. The UKOOA format is from the United Kingdom Offshore Operators Association. WITS is a format for transferring wellsite data (wellsite information transfer standard) as proposed by the International Association of Drilling Contractors (IADC).

A computational system may include or may provide access to a relational database management system (RDBMS). As an example, a query language such as SQL (Structured Query Language) may be utilized.

As an example, a machine can acquire seismic data and can process the seismic data via circuitry of the machine, which can include one or more processors and memory accessible to at least one processor. Such a machine can include one or more interfaces that can be operatively coupled to one or more pieces of equipment, whether by wire or wirelessly (e.g., via wireless communication circuitry). As an example, such a machine may be a seismic imager that can generate an image based at least in part on seismic data. Such an image can be a model according to one or more equations and may be an image of structure of a subterranean environment and/or an image of noise, which may be due to one or more phenomena. As an example, a seismic image can be in one or more types of domains. For example, consider a spatial and temporal domain where one dimension is spatial and another dimension is temporal. Such a domain may be utilized for seismic traces that are amplitude values with respect to time as acquired by a receiver of seismic survey equipment. As an example, time may be transformed to depth or other spatial dimension. In such an example, a seismic image can be in a spatial domain with two spatial dimensions.

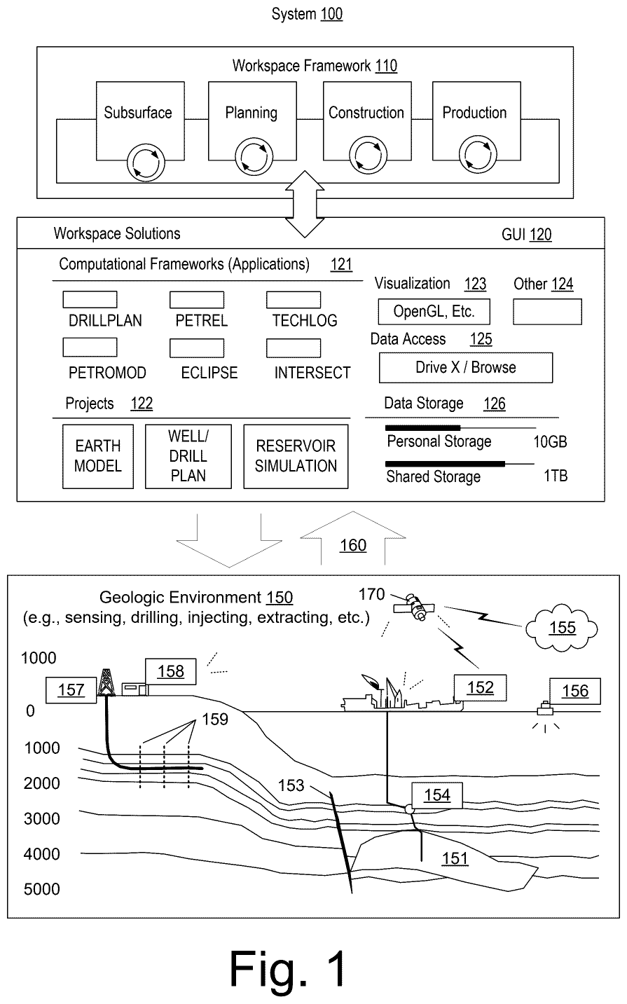

FIGS. 1, 2, 3, 4 and 5 show various examples of techniques, technologies, frameworks, environments, etc., that may be utilized for acquiring seismic data and/or processing seismic data for one or more purposes, for example, to characterize a subsurface region with respect to one or more physical phenomena, one or more field operations, etc.

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite 170 in communication with the network 155 that may be configured for communications, noting that the satellite 170 may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, and INTERSECT frameworks (SLB, Houston, Texas); noting that one or more other frameworks may be included, additionally, alternatively, etc. (e.g., consider the OMEGA framework (SLB, Houston, Texas), etc.).

The PETREL framework can be part of the DELFI cognitive exploration and production (E&P) environment (SLB, Houston, Texas), referred to as the DELFI environment, for utilization in geosciences and geoengineering, for example, to analyze subsurface data from exploration to production of fluid from a reservoir.

The DELFI environment is a secure, cognitive, cloud-based collaborative environment that integrates data and workflows with digital technologies, such as artificial intelligence and machine learning. As an example, such an environment can provide for operations that involve one or more frameworks. The DELFI environment may be referred to as the DELFI framework, which may be a framework of frameworks. As an example, the DELFI framework can include various other frameworks, which can include, for example, one or more types of models (e.g., simulation models, machine learning models, etc.).

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.).

As an example, a platform, such as, for example, the LUMI platform (SLB, Houston, Texas) may be utilized. The LUMI platform includes features that provide for artificial intelligence solutions as may be integrated with data management capabilities. The LUMI platform provides for flexible deployment options and an open, secure, and modular architecture, for example, to empower data-driven decision-making. The LUMI platform is operable with the DELFI environment and, hence, one or more of various frameworks. While various platforms, environments, frameworks, libraries, etc., are mentioned, a framework may be operable in an agnostic manner, for example, to be compatible with one or more other platforms, environments, frameworks, libraries, technologies, etc.

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, a model may be a simulated version of an environment. As an example, a simulator may include features for simulating physical phenomena in an environment based at least in part on a model or models.

Phenomena associated with a sedimentary basin (e.g., a subsurface region, whether below a ground surface, water surface, etc.) may be modeled using various equations (e.g., stress, fluid flow, phase, etc.). As an example, a numerical model of a basin may find use for understanding various processes related to exploration and production of natural resources (e.g., estimating reserves in place, drilling wells, forecasting production, controlling fracturing, etc.).

Where a sedimentary basin (e.g., subsurface region) includes various types of features (e.g., stratigraphic layers, fractures, faults, etc.), nodes, cells, etc., may represent, or be assigned to, such features. In turn, discretized equations may better represent the sedimentary basin and its features. As an example, a structured grid that can represent a sedimentary basin and its features, when compared to an unstructured grid, may allow for more simulations runs, more model complexity, less computational resource demands, less computation time, etc. In various examples, a structured approach and/or an unstructured approach may be utilized.

As an example, digital images and/or digital models of a subsurface region can be generated using digital seismic data (e.g., digital traces) acquired using reflection seismology as part of a seismic survey. A digital image can show subterranean structure, for example, as related to one or more of exploration for petroleum, natural gas, and mineral deposits. As an example, reflection seismology can include determining time intervals that elapse between initiation of a seismic wave at a selected shot point (e.g., the location where an explosion generates seismic waves) and the arrival of reflected or refracted impulses at one or more seismic detectors (e.g., sensing of seismic energy at one or more seismic receivers). As an example, a seismic air gun can be used to initiate seismic waves. As an example, one or more electric vibrators or falling weights (e.g., thumpers) may be employed at one or more sites. Upon arrival at the detectors, the amplitude and timing of seismic energy waves can be recorded, for example, as a seismogram (e.g., a record of ground vibrations).

As an example, a framework such as the PETREL framework may be utilized for processing seismic data for model generation where such a model may be a velocity model that defines layers of rock in a subsurface region. Such a model can serve as a basis for flow simulation, which may provide for indications of how fluids may be transported in the subsurface region (e.g., from a well to a reservoir, from a reservoir to a well, etc.). As an example, the DRILLPLAN framework can utilize seismic data-derived results for planning of one or more drilling operations, which, for example, may be executed in the field using field equipment controlled at least in part via the DRILLOPS framework (SLB, Houston, Texas).

The DRILLOPS framework may execute a digital drilling plan and ensure plan adherence, while delivering goal-based automation. The DRILLOPS framework may generate activity plans automatically individual operations, whether they are monitored and/or controlled on the rig or in town. Automation may utilize data analysis and learning systems to assist and optimize tasks, such as, for example, setting ROP to drilling a stand. A preset menu of automatable drilling tasks may be rendered, and, using data analysis and models, a plan may be executed in a manner to achieve a specified goal, where, for example, measurements may be utilized for calibration. The DRILLOPS framework provides flexibility to modify and replan activities dynamically, for example, based on a live appraisal of various factors (e.g., equipment, personnel, and supplies). Well construction activities (e.g., tripping, drilling, cementing, etc.) may be continually monitored and dynamically updated using feedback from operational activities. The DRILLOPS framework may provide for various levels of automation based on planning and/or re-planning (e.g., via the DRILLPLAN framework), feedback, etc.

As explained, seismic data can be a basis for one or more workflows, which can include exploration, planning, drilling, production, etc. Where processing of seismic data can be improved, various workflows can also be improved (e.g., more accurate results, lesser time for results, etc.).

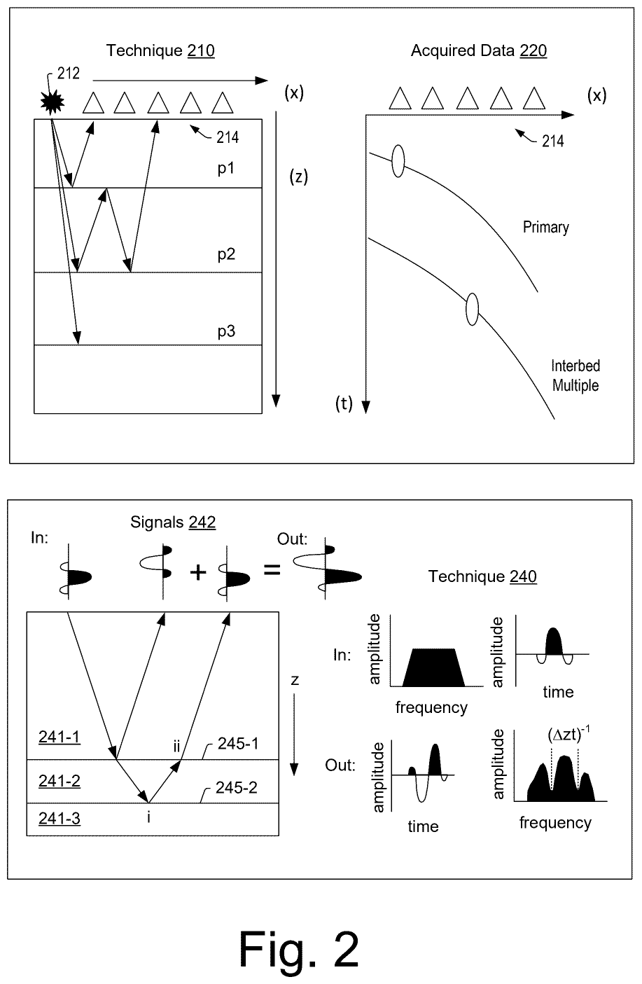

FIG. 2 shows an example of a technique 210 and acquired data 220, an example of a technique 240 and signals 242. As mentioned, a survey can include utilizing a source or sources and receivers. In the example technique 210, a source 212 is illustrated along with a plurality of receivers 214 that are spaced along a direction defined as an inline direction x. Along the inline direction x, distances can be determined between the source 212 and each of the receivers 214.

A subsurface region being surveyed includes features such a surface and subsurface horizons p1, p2 and p3 where one or more of such structural features can be interfaces where elastic properties (e.g., acoustic properties) can differ such that seismic energy is at least in part reflected. For example, a horizon can be an interface that might be represented by a seismic reflection, such as the contact between two bodies of rock having a difference in one or more of seismic velocity, density, porosity, fluid content, etc. In the example of FIG. 2, the technique 210 is shown to generate seismic reflections, which can include singly reflected and multiply reflected seismic energy. The acquired data 220 illustrate energy received by the receivers 214 with respect to time, t, and their inline position along the x-axis. As shown, singly reflected energy can be defined as primary (or primaries) while multiply reflected energy can be defined as multiples such as surface multiples, interbed multiples (e.g., IM), etc.

A primary can be defined as a seismic event whose energy has been reflected once; whereas, a multiple can be defined as an event whose energy has been reflected more than once. With respect to seismic interpretation, whether manual, semi-automatic or automatic, various techniques may aim to enhance primary reflections to facilitate interpretation of one or more subsurface interfaces. In other words, multiples can be viewed as extraneous signal or noise that can interfere with an interpretation process. As an example, one or more method can utilize multiples to provide useful signals. For example, consider a seismic survey designed to increase seismic signal coverage of a subsurface region of the Earth through use of multiples.

In FIG. 2, the technique 240 can include emitting energy with respect to time where the energy may be represented in a frequency domain, for example, as a band of frequencies. In such an example, the emitted energy may be a wavelet and, for example, referred to as a source wavelet which has a corresponding frequency spectrum (e.g., per a Fourier transform of the wavelet).

A wavelet can be a one-dimensional pulse defined by attributes such as, for example, amplitude, frequency and phase. A wavelet can originate as a packet of energy from a source point, having a specific origin in time, and be returned to one or more receivers as a series of events distributed in time and energy. The distribution is a function of velocity and density changes in the subsurface and the relative position of the source and receiver. Energy that returns cannot exceed what was input, so the energy in a received wavelet decays with time, for example, as more partitioning takes place at interfaces. Wavelets can also decay due to loss of energy as heat during propagation, which can be more extensive at higher frequencies. In various instances, received wavelets tend to contain less high-frequency energy relative to low frequencies at longer traveltimes. Some wavelets are known by their shape and spectral content, such as the Ricker wavelet (e.g., a zero-phase wavelet such as the second derivative of the Gaussian function or the third derivative of the normal-probability density function).

As an example, a geologic environment may include layers 241-1, 241-2 and 241-3 where an interface 245-1 exists between the layers 241-1 and 241-2 and where an interface 245-2 exists between the layers 241-2 and 241-3. As illustrated in FIG. 2, a wavelet may be first transmitted downward in the layer 241-1; be, in part, reflected upward by the interface 245-1 and transmitted upward in the layer 241-1; be, in part, transmitted through the interface 245-1 and transmitted downward in the layer 241-2; be, in part, reflected upward by the interface 245-2 (see, e.g., “i”) and transmitted upward in the layer 241-2; and be, in part, transmitted through the interface 245-1 (see, e.g., “ii”) and again transmitted in the layer 241-1. In such an example, signals (see, e.g., the signals 242) may be received as a result of wavelet reflection from the interface 245-1 and as a result of wavelet reflection from the interface 245-2. These signals may be shifted in time and in polarity such that addition of these signals results in a waveform that may be analyzed to derive some information as to one or more characteristics of the layer 241-2 (e.g., and/or one or more of the interfaces 245-1 and 245-2). For example, a Fourier transform of signals may provide information in a frequency domain that can be used to estimate a temporal thickness (e.g., Δzt) of the layer 241-2 (e.g., as related to acoustic impedance, reflectivity, etc.).

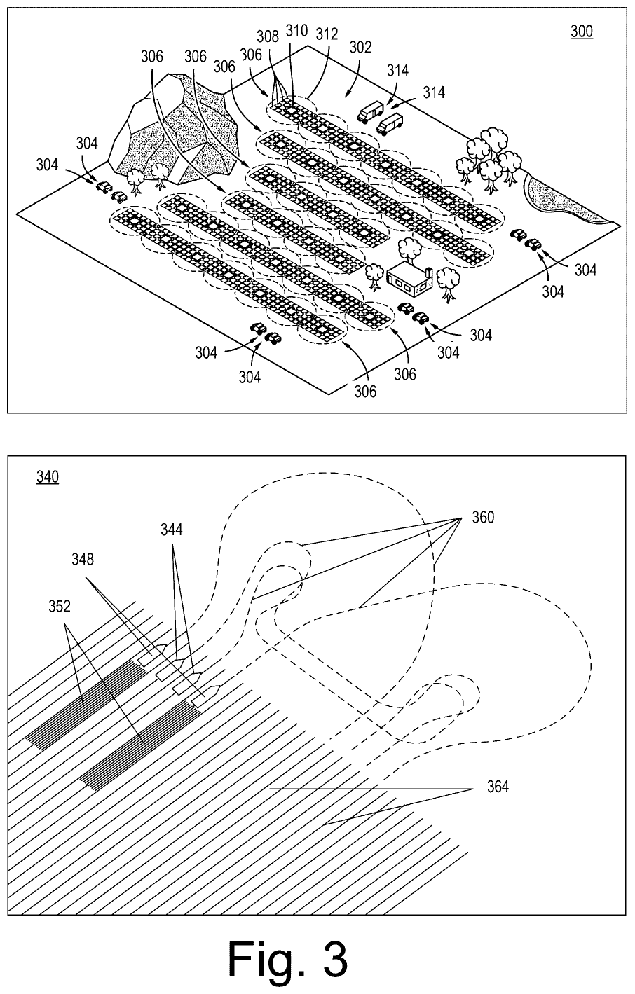

FIG. 3 shows an example of a simplified schematic view of a land seismic data acquisition system 300 and an example of a simplified schematic view of a marine seismic data acquisition system 340.

As shown with respect to the system 300, an area 302 to be surveyed may or may not have physical impediments to direct wireless communication between a recording station 314 (which may be a recording truck) and a vibrator 304. A plurality of vibrators 304 may be employed, as well as a plurality of sensor unit grids 306, each of which may have a plurality of sensor units 308.

As illustrated in FIG. 3 with respect to the system 300, approximately 24 to about 28 sensor units 308 may be placed in a vicinity (a region) around a base station 310. The number of sensor units 308 associated with each base station 310 may vary from survey to survey. Circles 312 indicate an approximate range of reception for each base station 310.

In the system 300 of FIG. 3, the plurality of sensor units 308 may be employed in acquiring and/or monitoring land-seismic sensor data for the area 302 and transmitting the data to the one or more base stations 310. Communications between the vibrators 304, the base stations 310, the recording station 314, and the seismic sensors 308 may be wireless (at least in part via air for a land-based system; or optionally at least in part via water for a sea-based system).

In the system 340 of FIG. 3, one or more source vessels 344 may be utilized with one or more streamer vessels 348 or a vessel or vessels may tow both a source or sources and a streamer or streamers 352. In the example of FIG. 3, the vessels 344 and 348 (e.g., or just the vessels 348 if they include sources) may follow predefined routes (e.g., paths) for an acquisition geometry that includes inline and crossline dimensions. As shown, routes 360 can be for maneuvering the vessels to positions 364 as part of the survey. As an example, a marine seismic survey may call for acquiring seismic data during a turn (e.g., during one or more of the routes 360).

The example systems 300 and 340 of FIG. 3 demonstrate how surveys may be performed according to an acquisition geometry that includes dimensions such as inline and crossline dimensions, which may be defined as x and y dimensions in a plane or surface where another dimension, z, is a depth dimension. As explained, time can be a proxy for depth, depending on various factors, which can include knowing how many reflections may have occurred as a single reflection may mean that depth of a reflector can be approximated using one-half of a two-way traveltime, some indication of the speed of sound in the medium and positions of the receiver and source (e.g., corresponding to the two-way traveltime (TWT)).

Two-way traveltime (TWT) can be defined as the elapsed time for a seismic wave to travel from its source to a given reflector and return to a receiver (e.g., at a surface, etc.). As an example, a minimum two-way traveltime (TWTₘᵢₙ) can be defined to be that of a normal-incidence wave with zero offset.

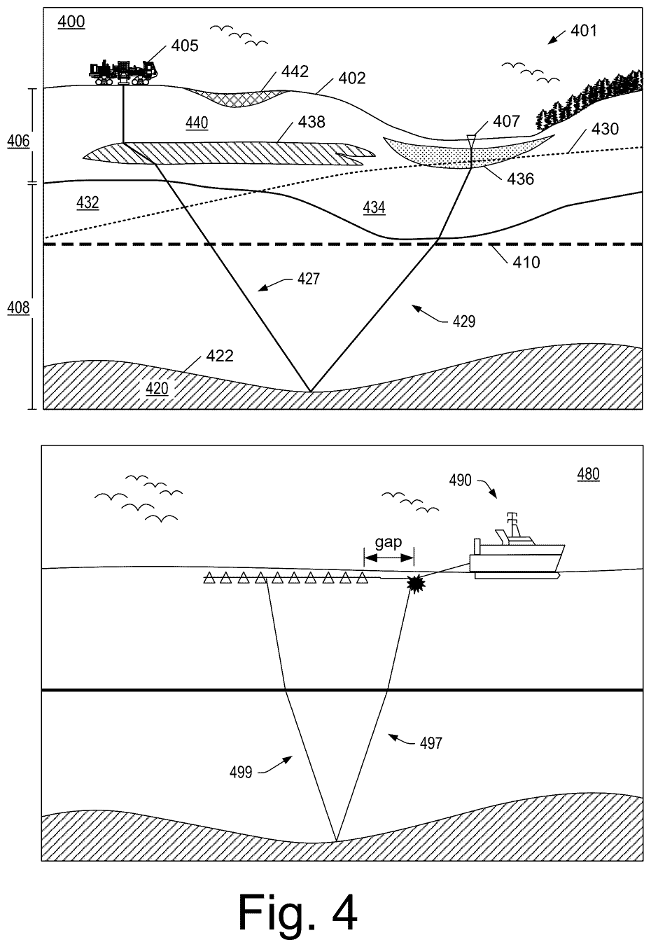

FIG. 4 shows an example of a land system 400 and an example of a marine system 480. The land system 400 is shown in a geologic environment 401 that includes a surface 402, a source 405 at the surface 402, a near-surface zone 406, a receiver 407, a bedrock zone 408 and a datum 410 where the near-surface zone 406 (e.g., near-surface region) may be defined at least in part by the datum 410, which may be a depth or layer or surface at which data above are handled differently than data below. For example, a method can include processing seismic data that aims to “place” the source 405 and the receiver 407 on a datum plane defined by the datum 410 by adjusting (e.g., “correcting”) traveltimes for propagation through the near-surface region (e.g., a shallower subsurface region).

In the example system 400 of FIG. 4, the geologic environment 401 can include various features such as, for example, a layer 420 that defines an interface 422 that can be a reflector, a water table 430, a leached zone 432, a glacial scour 434, a buried river channel 436, a region of material 438 (e.g., ice, evaporates, volcanics, etc.), a high velocity zone 440, and a region of material 442 (e.g., Eolian or peat deposits, etc.).

In FIG. 4, the land system 400 is shown with respect to downgoing rays 427 (e.g., downgoing seismic energy) and upgoing rays 429 (e.g., upgoing seismic energy). As illustrated the rays 427 and 429 pass through various types of materials and/or reflect off of various types of materials.

Various types of seismic surveys can contend with surface unevenness and/or near-surface heterogeneity. For example, a shallow subsurface can include large and abrupt vertical and horizontal variations that may be, for example, caused by differences in lithology, compaction cementation, weather, etc. Such variations can generate delays or advances in arrival times of seismic waves passing through them relative to waves that do not. By accounting for such time differences, a seismic image may be of enhanced resolution with a reduction in false structural anomalies at depth, a reduction in mis-ties between intersecting lines, a reduction in artificial events created from noise, etc.

In FIG. 4, the datum 410 is shown, for example, as a plane, below which strata may be of particular interest in a seismic imaging workflow. In a three-dimensional model of a geologic environment, a near surface region may be defined, for example, at least in part with respect to a datum. As an example, a velocity model may be a multidimensional model that models at least a portion of a geologic environment.

In the example of FIG. 4, the source 405 can be a seismic energy source such as a vibrator. As an example, a vibrator may be a mechanical source that delivers vibratory seismic energy to the Earth for acquisition of seismic data. As an example, a vibrator may be mounted on a vehicle (e.g., a truck, etc.). As an example, a seismic source or seismic energy source may be one or more types of devices that can generate seismic energy (e.g., an air gun, an explosive charge, a vibrator, etc.).

As an example, a sensor unit can include a geophone, which may be configured to detect motion in a single direction. As an example, a geophone may be configured to detect motion in a vertical direction. As an example, three mutually orthogonal geophones may be used in combination to collect so-called 3C seismic data. As an example, a sensor unit that can acquire 3C seismic data may allow for determination of type of wave and its direction of propagation. As an example, a sensor assembly or sensor unit may include circuitry that can output samples at intervals of 1 milliseconds (ms), 2 ms, 4 ms, etc. As an example, an assembly or sensor unit can include an analog-to-digital converter (ADC) such as, for example, a 24-bit sigma-delta ADC (e.g., as part of a geophone or operatively coupled to one or more geophones). As an example, a sensor assembly or sensor unit can include synchronization circuitry such as, for example, GPS synchronization circuitry with an accuracy of about plus or minus 12.5 microseconds. As an example, an assembly or sensor unit can include circuitry for sensing of real-time and optionally continuous tilt, temperature, humidity, leakage, etc. As an example, an assembly or sensor unit can include calibration circuitry, which may be self-calibration circuitry.

In FIG. 4, the system 480 includes equipment 490, which can be a vessel that tows one or more sources and one or more streamers (e.g., with receivers). In the system 480, a source of the equipment 490 can emit energy at a location and a receiver of the equipment 490 can receive energy at a location. The emitted energy can be at least in part along a path of the downgoing energy 497 and the received energy can be at least in part along a path of the upgoing energy 499.

Some examples of techniques that can process seismic data include migration and migration inversion, which may be implemented for purposes such as structural determination and subsequent amplitude analysis. In seismic exploration, signal can be defined as a part of a recorded seismic record (e.g., events) that is decipherable and useful for determining subsurface information (e.g., relevant to the location and production of hydrocarbons, etc.). Migration and migration inversion are techniques that can be used to extract subsurface information from seismic reflection data.

As mentioned, seismic data can be in a particular format such as, for example, a seismic volume. To understand the concept of a volume of data, consider a room that is divided up into points one foot apart such that each point has an (x, y, z) coordinate and a data value such as temperature at that point. An array that stores the temperature data values can provide temperature as a function of (x, y, z). For a 3D seismic data volume, rather than having a z-axis in strictly in distance, it may be in distance or in time, such as two-way traveltime (TWT), and, rather than temperature at a point, a point can be a seismic amplitude (e.g., an amplitude data value).

A 3D seismic data set can be a box full of numbers, where each number represents a measurement (e.g., amplitude) and where each number has an (x, y, z) position in the box. For a point in the interior of the box, three planes pass through it parallel to the top, front, and side of the box.

Where data values are amplitudes, they may be representing using a scale such as a grayscale, a color scale, etc. In a grayscale representation, dark and light bands in a 2D seismic slice of amplitude with respect to TWT and inline direction may relate to rock boundaries (e.g., reflectors in a subsurface formation).

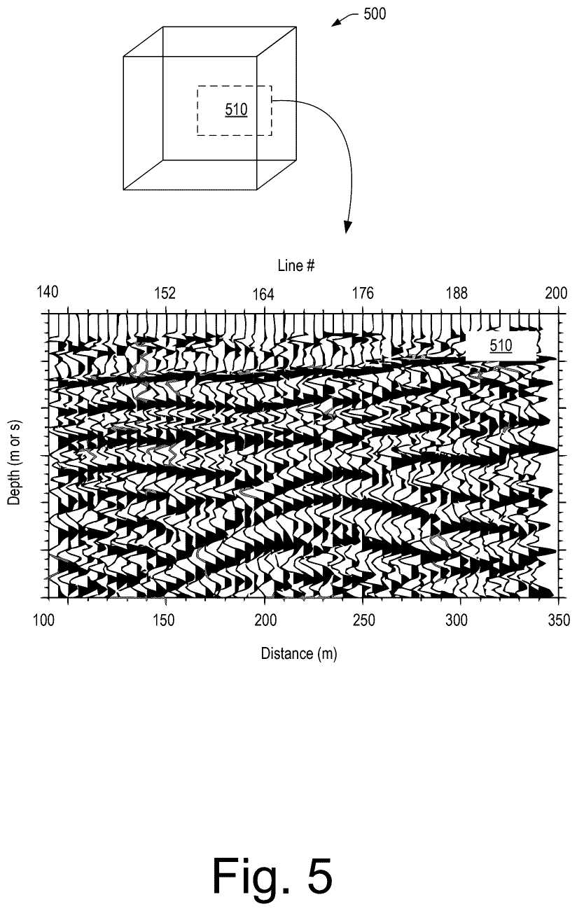

FIG. 5 shows an example of a seismic volume 500 and a seismic slice 510 as accessed from the seismic volume 500 where the seismic slice 510 is presented as amplitude values with respect to depth (e.g., meters or seconds) and distance (e.g., meters) or line number (e.g., “Line #” of a crossline coordinate or an inline coordinate). While the seismic slice 510 is shown to be orthogonal to coordinates of the seismic volume 500, it may be at an angle that does not align with one or more of the coordinates. In such an example, interpolation or another technique may be utilized to generate a slice.

In various instances, seismic data are accessed in a manner that corresponds to coordinates of a seismic volume. For example, an instruction may include coordinates and/or dimensions along coordinate axes to facilitate access of seismic data from a seismic volume.

In the example of FIG. 5, the seismic slice 510 has the appearance of an image where seismic waveforms run vertically, which may be referred to as variable area/wiggle traces. Wiggle traces stems from pen and paper recorders, such as those of a seismograph. As an example, rather than represent seismic waveforms, as mentioned, a scale may be utilized. For example, a scale can be utilized to represent amplitudes. As an example, a blue, white and red color scale may be utilized where gradational blue is utilized for amplitude peaks (e.g., positive values) and gradational red is used for amplitude troughs (e.g., negative values). As an example, a variable intensity scale may be utilized that can provide for presentation of a balanced appearance of positive and negative amplitudes, presentation of data without overlap (e.g., overlapping wiggle traces), presentation of higher amplitude (e.g., more negative or more positive) without mislocation, etc. As an example, a multi-gradational color scheme may help to enhance amplitude events and be particularly applicable to identification of hydrocarbon effects, identification of reservoir reflectors, etc. As an example, a single-gradational color scheme may, on the other hand, enhance low amplitude events and be particularly useful for identification of faults. As mentioned, a variable intensity grayscale scheme may be utilized.

As an example, an enhanced dynamic range color scheme may be utilized, which may facilitate making various types of stratigraphic identifications. For example, consider a cyan-blue-white-red-yellow scheme. Such a scheme may help in identification of gas-oil contact (e.g., a gas bright spot may be higher in amplitude than an oil bright spot).

An interpreter may aim to look for amplitude trends and patterns, low amplitude indications and high amplitude indications. An interpreter may look for character and lateral changes. As mentioned, a color approach may facilitate pairing, identification of problems with data phase and polarity, etc.

While various aspects as may be seen in vertical seismic slices have been mentioned, a scheme may be suitable for facilitating interpretation of a horizontal seismic slice (e.g., at a constant TWT, a constant depth, etc.). As an example, a gradational color scheme may facilitate interpretation of features in a horizontal seismic slice (e.g., trends, patterns, etc.).

As an example, a workflow may involve implementing one or more techniques that can process seismic data. For example, consider general surface multiple prediction (GSMP), which is a 3D implementation of surface-related multiple elimination (SRME). GSMP may be utilized to predict complex multiples, including diffracted and scattered multiple energy. GSMP may be implemented to address challenges of sparse, missing or irregular field data, providing effective results in various geophysical situations, for example, consider scenarios using wide angle offset (WAZ), towed-streamer surveys, etc.

Through implementation of GSMP, seismic data can be used to predict multiples in a 3D manner. GSMP is a data-driven technology that can utilize a recorded wavefield at the surface. As such, assumptions about the nature of the subsurface and/or corrections for irregularities in acquisition are not necessarily required. GSMP can predict the multiples and attenuate them on the basis of processing recorded data.

In areas with complex imaging challenges, GSMP helps to ensure the preservation of complex primary events such as double bounces, which may be attenuated with techniques such as Radon demultiplex techniques. Unlike various other implementations of 3D SRME, GSMP does not demand regularization, extrapolation to zero offset, or interpolation of shot and receiver sampling intervals prior to performing GSMP. In GSMP, interpolation, regularization, and extrapolation may be carried out on-the-fly. As to multiple model quality, GSMP can predict multiples at true azimuth, ensuring that a multiple model accurately matches multiples in input data. The GSMP technique, being data-driven, can reduce demands for assumptions, which, in turn, can provide for higher quality results.

As an example, a GSMP technique may provide for predicting a plurality of surface multiples for a plurality of traces in a record of seismic data. For example, consider predicting a plurality of surface multiples for a plurality of traces in a record of seismic data by providing a plurality of target traces at a nominal offset and a nominal azimuth; selecting a plurality of pairs of input traces, where the midpoints of the input traces in each pair are separated by half the nominal offset and the azimuth of a line connecting the midpoints of the input traces in each pair is equal to the nominal azimuth; convolving the selected pairs of input traces to generate a plurality of convolutions; and applying a 3D operator to the convolutions. As an example, a GSMP technique may involve providing a plurality of target traces at a nominal offset and a nominal azimuth; selecting a plurality of pairs of input traces, where the midpoints of the input traces are separated by half the nominal offset and the azimuth of a line connecting the midpoints of the input traces is equal to the nominal azimuth; convolving the selected pairs of input traces to generate a plurality of convolutions; and applying a 3D operator to the convolutions, where the 3D operator is a 3D demigration operator.

GSMP can demand a relatively large number of inputs to model each of a number of locations where, for example, locations that are relatively close to one another may share some of their inputs. As an example, the phrase relatively close may mean nearby or neighboring, which may be quantified based on one or more criterion. In GSMP, a “nearby” concept may be 3D to 5D due to the manner in which GSMP may define searching. As an example, a framework may provide for determining an order in which to model locations where the order may aim to maximize input sharing between subsequent locations. As an example, a framework may implement a clustering approach that utilizes clusters rather than considering locations on a per-location basis. For example, rather than comparing each location to another location in a pairwise manner, a framework may employ one or more clustering techniques that may provide for determining an order where such clustering reduces computational demand (e.g., improves computational efficiency); noting that ordering may also provide for reducing computational demand (e.g., improving computational efficiency).

As explained, GSMP demands accessing data, which may be referred to as data reads or input reads. Such accessing may include transmission of a request and reception of data responsive to the request. Data reads may occur in a distributed or other type of computational environment where some amount of latency may be associated with each request and response, which may, in various instances, be dependent on amount of data to be accessed.

As an example, a framework may provide for minimizing input reads for GSMP. For example, consider a framework that may aim to minimize initial, overall, and sequential trace (e.g., input location) distribution in a manner that can reduce input reads (e.g., file system reads, etc.). As an example, a framework may provide for maximizing the number of convolutions per distributed trace. For example, consider maximizing re-use of locations within a work item. As explained, a framework may utilize clustering where a cluster may be associated with a work item.

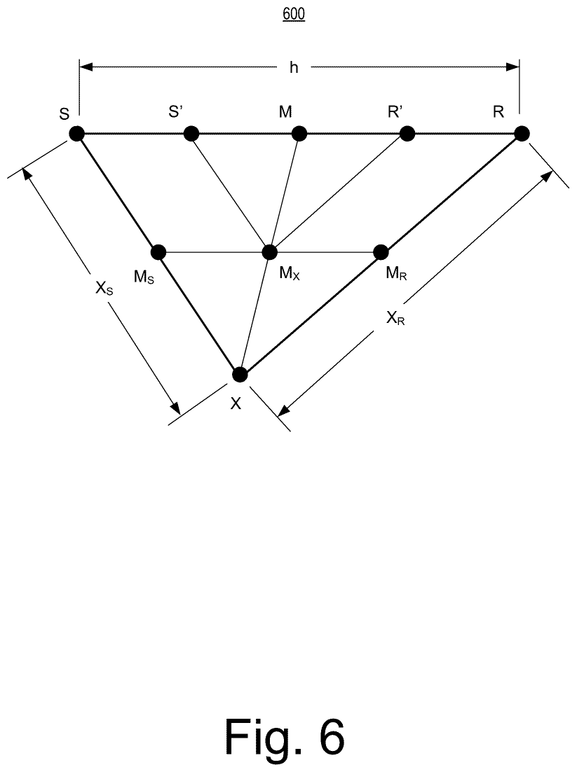

FIG. 6 shows an example of a plan view 600 of an acquisition geometry in accordance with one or more embodiments. Surface multiples for a trace (S, R), with source at S and receiver at R, are to be predicted. M and h are defined as the midpoint and offset of (S, R) respectively. X is defined as a potential downward reflection point (DRP) for the surface multiples.

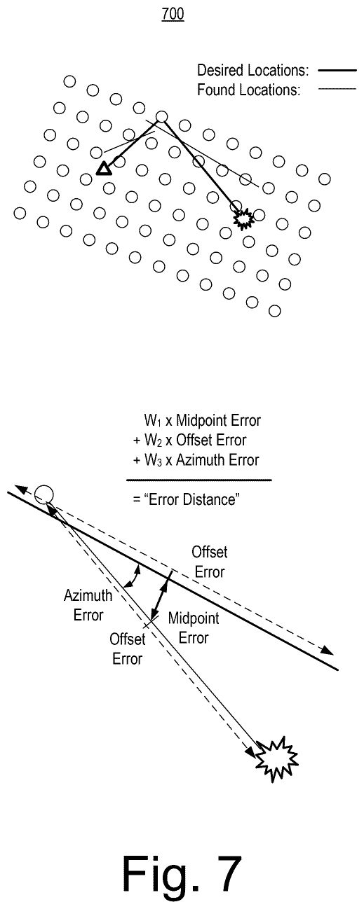

FIG. 7 shows an example of a search technique 700 pertaining to searching in GSMP. As explained, GSMP may employ multi-dimensional convolution where, for example, a search technique searches for pairs of inputs, interpolating each found input to a desired location, convolving pairs of inputs and summing convolutions. As shown in FIG. 7, there may be desired locations versus found locations and associated error distances, which may be a combination of multiple errors such as, for example, one or more of midpoint error (see straight double-headed arrow), offset error (see dashed lines) and azimuth error (see curved double-headed arrow). As an example, an error distance may be a square root of a sum of squares as to midpoint error, offset error and azimuth error. As an example, azimuth error may be determined using Cartesian terms rather than inline offset and crossline offset. As an example, weights may be used where, for example, a midpoint error weight, W₁, may be set to unity; noting that weights W₂ and W₃ may be employed.

As explained, a pairwise approach by itself may be computationally demanding. As explained, an approach that involves clustering may help to reduce computational demands. As explained, a clustering approach may leverage a concept of overlap, which may be defined using one or more criteria.

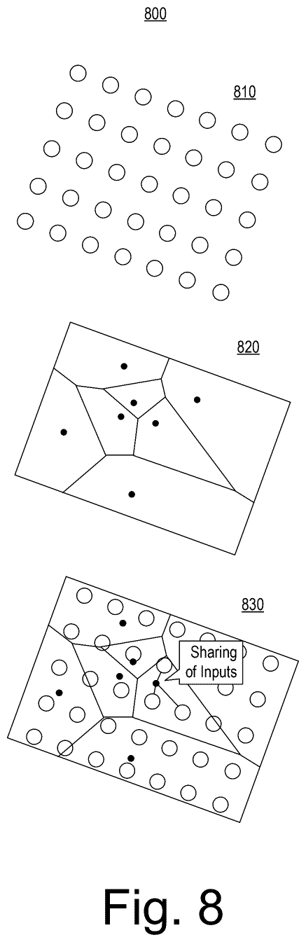

FIG. 8 shows an example of a clustering technique 800 that may provide for generation of clusters as to overlap, which may provide for sharing of input. As shown, the clustering technique 800 may involve receiving desired locations 810 (e.g., according to a grid, etc.), receiving input locations 820, and finding (e.g., searching for) individual input locations that may be shared by multiple desired locations 830. For example, as shown in FIG. 8, a single input location may be shared by three different desired locations (see small filled circle and three large open circles). In such an example, once the input location is accessed (e.g., an input read) it may be read once and utilized with respect to each of the three different desired locations. In such an example, computational efficiency may be gained.

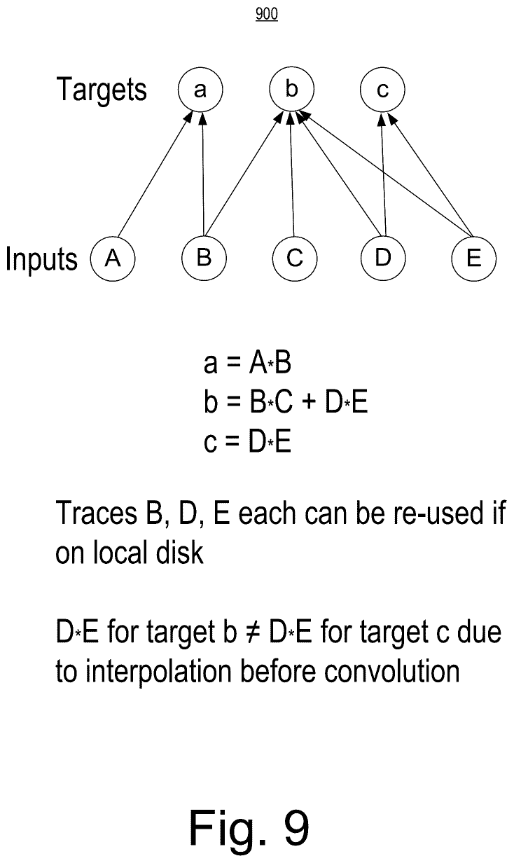

FIG. 9 shows an example of an interpolation approach 900 that may be part of a multi-dimensional convolution where, for example, each found input is interpolated to a desired location. As shown, for sake of simplicity, consider inputs A, B, C, D, and E and targets a, b, and c (e.g., desired locations). As explained, inputs can be traces (e.g., seismic traces) where traces may be stored on one or more storage devices, which may be local and/or remote from a workstation (e.g., local computing device, etc.). As an example, a remote server may store seismic traces. In the example of FIG. 9, the inputs B, D, and E can each be re-used once accessed. For example, where the input B is accessed and stored locally for target a, it may be re-used for target b, where the input D is accessed and stored locally for target b, it may be re-used for target c, and where the input E is accessed and stored locally for target b, it may be re-used for target c. However, note that D*E for target b is not the same as D*E for target c due to interpolation before convolution.

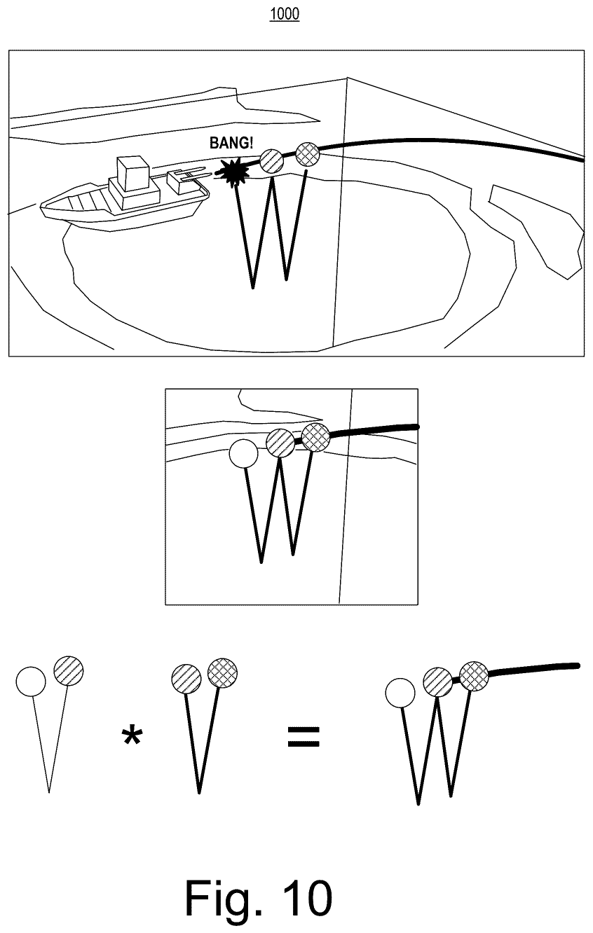

FIG. 10 shows an example of a seismic survey 1000 where a source shot generates receiver data as received at two different receivers, which may provide for defining the spatial concept of a GSMP aperture. As to combinatorial optimization for GSMP work partitions, the spatial concept of GSMP aperture may be taken into account. In the example of FIG. 10, after firing the source, there is an echo off the sea floor that may be recorded by a number of receivers (e.g., receivers of a streamer, etc.). As indicated, nearby recordings can include parts of an echo, which may be due to, for example, reflections such as a reflection at an air-water interface. For example, the slanted-line filled circle receiver may record a primary while the cross-hatched filled circle receiver may record a multiple due to reflection of the primary at an air-water interface, followed by downward going energy reflecting off the seabed to generate upward going energy received by the red receiver. Accordingly, nearby recordings can include parts of an echo.

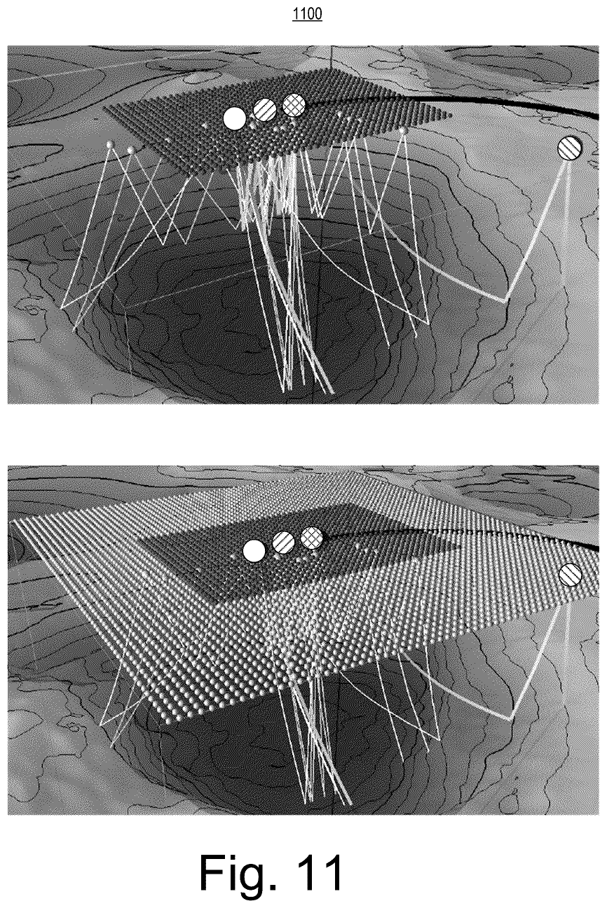

FIG. 11 shows examples of boxes of recordings 1100, where a box may define an aperture. For example, consider a small box and a big box where the big box includes most of the echoes (e.g., more than the smaller box). As an example, a single model may have associated recordings (e.g., traces) that may number in the thousands, for example, from 10,000 to 100,000 or more.

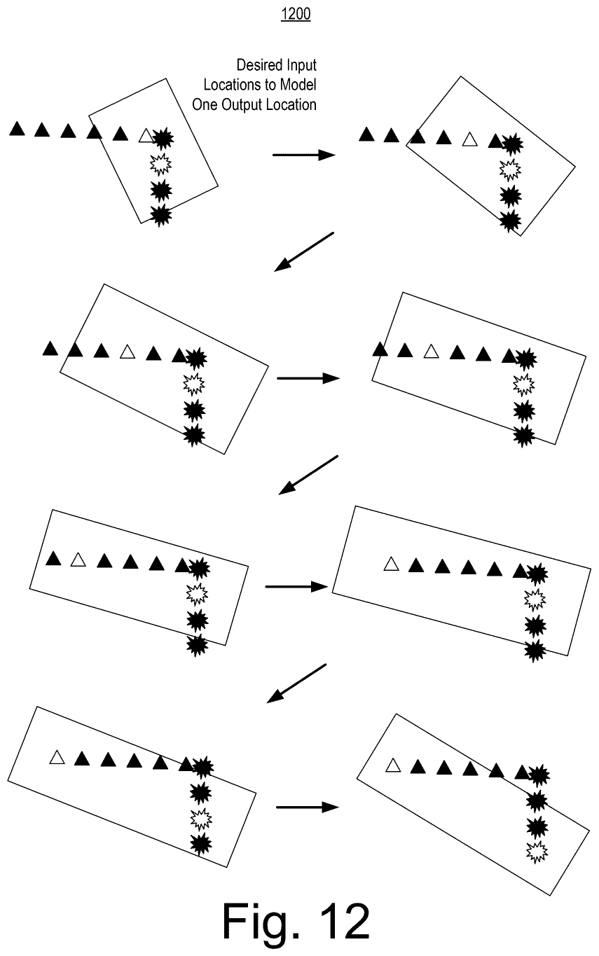

FIG. 12 shows an example technique 1200 where a box may move to model each location such that the box may help to define desired input locations to model one output location. In the example technique 1200, sources and receivers are shown where a progression may move from a closest receiver to a further receiver iteratively, where, once completed, a source location may be incremented. As shown, a box can change in dimensions and angle, for example, to accommodate a source and receiver pair. In such an approach, a box may grow as distance between a source and a receiver increases.

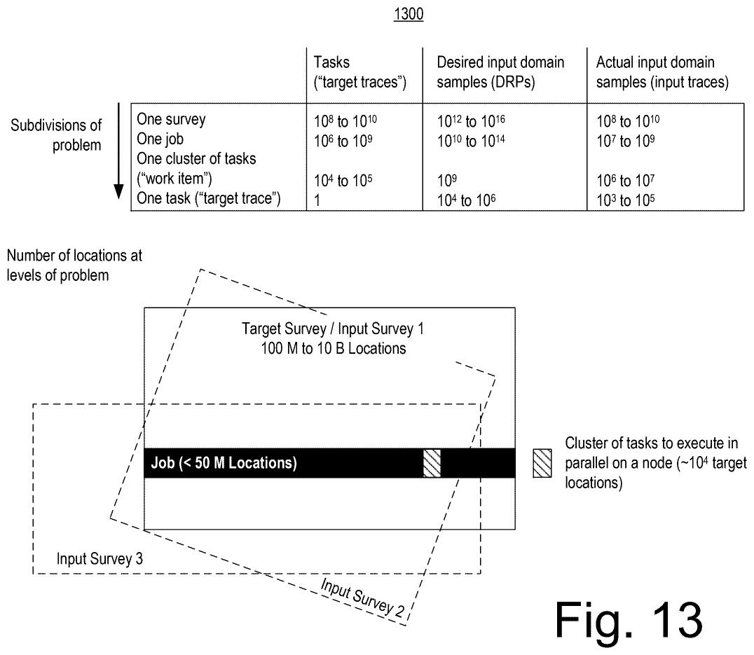

FIG. 13 shows an example of a number of locations at levels of a GSMP technique 1300. As shown, a full target survey, which may have billions of locations (e.g., 50 billion), may be broken down into a job with work items (e.g., a cluster or clusters of tasks) where a job size may consider millions of locations to model (e.g., consider 50 million) and a work item may consider thousands of locations to model (e.g., tasks or target traces) for millions of desired input locations (e.g., downward reflection points (DRPs), desired input domain samples, etc.) (e.g., consider millions as being greater than 1 million up to 1 billion or more). As explained, a framework may provide for re-use of many input traces (e.g., seismic data) via a technique that may involve interpolation. As explained, re-use can provide for computational efficiency, particular where access requests demand some amount of time and thereby introduce some amount of latency. As explained, a method may provide for determining when data may be intelligently re-used upon access, which can result in fewer data calls, etc. (e.g., whether by an application programming interface, a database management framework, etc.). Fewer data calls may provide for efficiency in terms of time, power, emissions, etc.

In the example of FIG. 13, regions for multiple surveys are shown, including an input survey 1, an input survey 2, and an input survey 3. As indicated, these surveys may overlap to some extent, which may provide for opportunities for efficient data access and data re-use.

As explained, a framework may provide for ordering of work items. As an example, a framework may provide for determining ordering heuristics, which may be based on one or more techniques. As an example, a technique may include utilization of analyses on one or more prior surveys, for example, as to computational and/or data transfer demands (e.g., computational related operational inefficiencies).

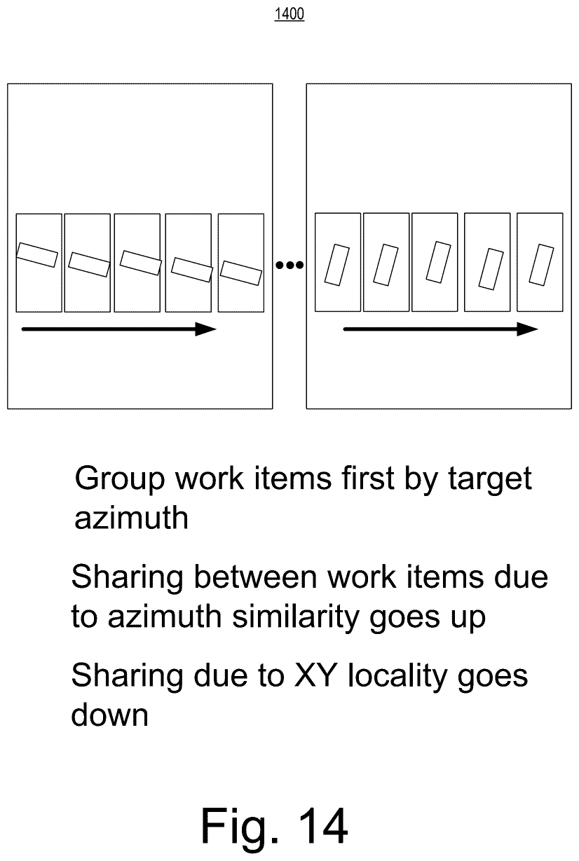

FIG. 14 shows an example of a method 1400 that includes grouping work items by target azimuth where sharing between work items due to azimuth similarity goes up, noting that, for this particular example, sharing due to X,Y locality tends to go down. As an example, work items themselves may be made more localized, which may conserve on convolution cost (e.g., in addition to data transfer). Such an approach is an improvement over a method that involves no sharing between work items. Without sharing, a substantial amount of time may be wasted waiting for data to be accessed, where data may be accessed each time as required.

As an example, a method may include defining an input domain for each task, generating multiple samples from an input domain for each task, clustering samples from an input domain to generate clusters, assigning multiple input-domain clusters to each task, clustering multiple tasks based on sharing network of input-domain clusters, and ordering clusters of tasks.

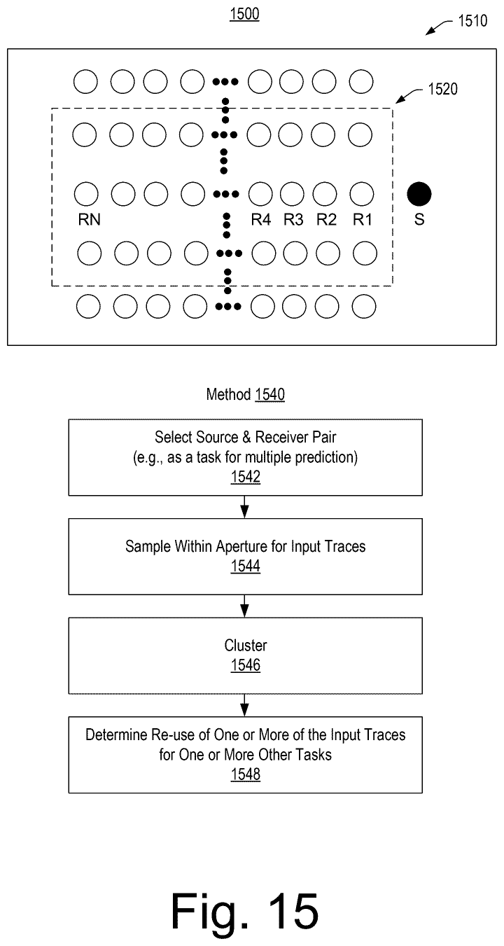

FIG. 15 shows an example of a scheme 1500 for implementation with a GSMP technique. As shown, seismic data may be acquired for a region 1510 using an arrangement of one or more sources(S) and a number of receivers (R). For example, consider an arrangement that utilizes one source and 10 strings of receivers where each of the strings includes 640 receivers. In such an example, the total number of receivers is 6400. Hence, when the source is fired (a shot), energy from the shot will be directed into a subsurface region where a portion of that energy is reflected one or more times towards surface where the reflected energy is recorded by a number of the 6400 receivers. In such an example, the seismic data recorded by the receivers may be stored in a seismic volume, which is an array of seismic data. Such a seismic volume may be sparse. Ultimately, processing may aim to generate values that represent properties, spatially, within the subsurface region. For example, consider the seismic slice 510 of FIG. 5 as being a representation of seismic data that may represent properties of a subsurface region.

In the example of FIG. 15, an area 1520 represented by dashed lines may be an aperture that is a spatial aperture for a particular source and receiver pair. For example, consider the area 1520 as being an aperture for the source(S) and a receiver number 310 (e.g., R310, not labeled) of a string of 640 receivers (e.g., N is equal to 640). In such an example, the area 1520 may represent a region in which multiples may exist for the source and receiver pair where such multiples may be present in recorded seismic data from other source and receiver pairs (e.g., other receivers). In such an approach, the aperture can include locations of various other receivers.

As an example, apertures for neighboring target traces may substantially overlap. In this case, a modeling process for neighboring target traces may also share input recorded traces such that the modeling process on a given compute node (e.g., in a cloud platform environment) may use a single input trace multiple times. In such an approach, a compute node can retrieve an input trace once, while using it multiple times.

In a GSMP technique, where an aim is to predict multiples for a source and receiver pair using recorded seismic data, knowing what recorded seismic data are likely to be relevant can be part of a workflow (e.g., part of a GSMP technique) can be beneficial. As explained, a process may utilize an area, such as, for example, an aperture. In such an approach, the aperture may differ for various source and receiver pairs. For example, in the region 1510, the area 1520 may be shifted and/or shaped and/or sized and/or angled differently for receivers in another string, etc. As explained, some seismic data may be relevant to multiple different source and receiver pairs and, where seismic data or regions of relevance overlap, seismic data within an overlapping region may be re-used. For example, accessed once from a data storage and utilized for multiple, different source and receiver pairs such as for multiple prediction (e.g., using GSMP, etc.).

As shown in FIG. 15, a method 1540 can include a selection block 1542 for selecting a source and receiver pair (e.g., as may be utilized as part of a task for multiple prediction), a sample block 1544 for sampling within an aperture for input traces (e.g., recorded seismic data) that may be considered relevant for a task associated with the source and receiver pair, a cluster block 1546 for clustering the sampled input traces (e.g., input trace locations) for the selected source and receiver pair with other sampled input traces for other source and receiver pairs, and a determination block 1548 for determining whether re-use is possible of one or more of the input traces for one or more other tasks.

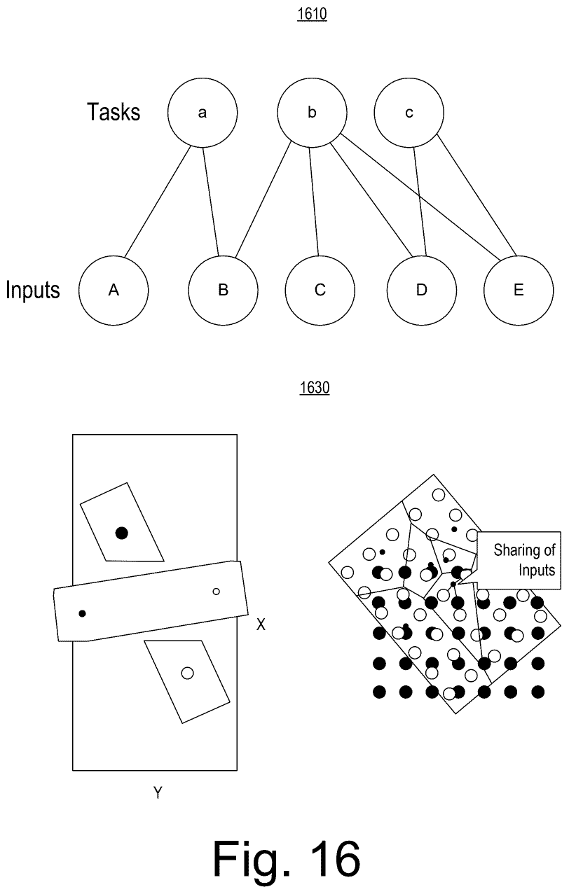

FIG. 16 shows example graphics 1610 and 1630 as to re-use of data. For example, in the graphic 1610, various tasks a, b, and c can utilize one or more of inputs A, B, C, D, and E. For example, the tasks a and b can both utilize the input B. Hence, if the input B is loaded (e.g., data accessed) for performing task a, then task b may be expedited if it is performed with the loaded input B. Thus, an order of performing the tasks may be determined at least in part on the basis of data re-use. As to the graphic 1630, it shows a plan view of a region of a seismic survey where sharing of inputs (e.g., input re-use) may be performed as part of a workflow involving tasks that depend on inputs.

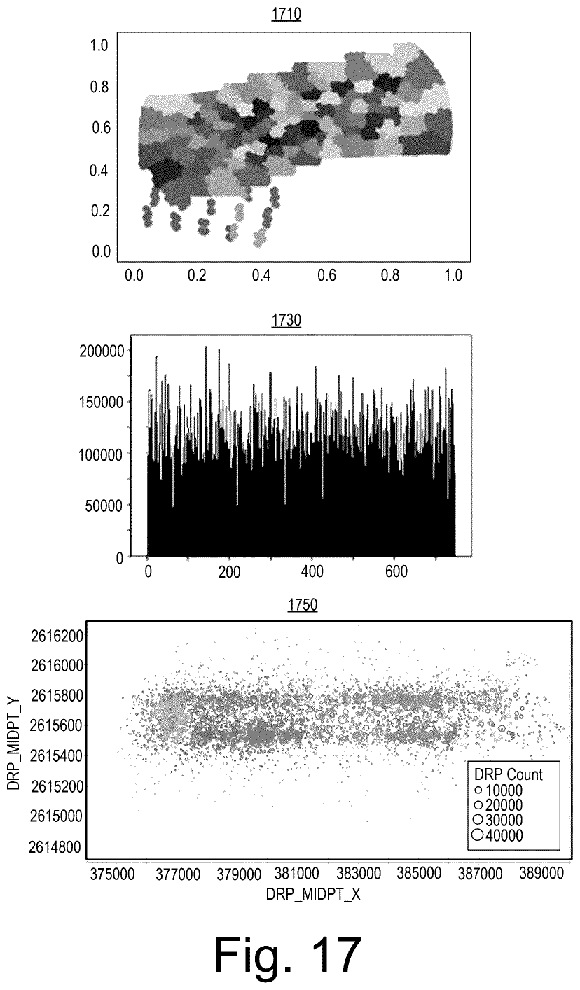

FIG. 17 shows example plots 1710, 1730, and 1750 where the plot 1710 illustrates a clustering process that may be performed in an N-dimensional space, where the plot 1730 shows an input domain samples cluster distribution, and where the plot 1750 shows clusters with sizing for different downward reflection point counts (see, e.g., size of circles). As to the plot 1750, it is shown with respect to axes for DRP midpoint in X and Y directions. As such, the plot 1750 may be considered a plan view of DRP locations in two dimensions.

As to the plots 1710 and 1750, they may be for projected input domain samples as clustered and the plot 1730 may be for projected input domain samples as to cluster distribution.

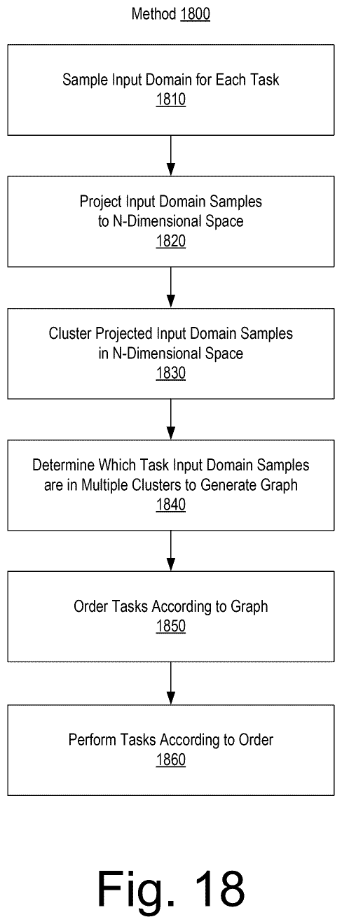

FIG. 18 shows an example of a method 1800 that can include a sample block 1810 for sampling an input domain for each of a number of tasks, a projection block 1820 for projecting input domain samples to an N-dimensional space, a cluster block 1830 for clustering projected input domain samples of the N-dimensional space, a determination block 1840 for determining which task input domain samples are in multiple clusters to generate a graph, an order block 1850 for ordering tasks according to the graph, and a performance block 1860 for performing tasks according to the order.

As explained, an ordering process can be implemented as part of a seismic processing computer application to order work to be performed by a seismic processing technique. In such an approach, the seismic processing technique can involve various tasks where, for example, tasks may be performed in an order that can expedite execution, for example, by reducing data loading demands. As explained, ordering can be based at least in part on sharing of input data between tasks. As an example, an ordering process may aim to maximize overlap in input data of subsequent tasks and locality within a task. As an example, a technique may run multiple tasks in parallel and/or may runs two or more tasks in sequence on a common machine (e.g., a node in a cloud computing environment). As explained, ordering may help to reduce total data reading to complete a number of tasks.

As explained, a method can take as input geographic locations of input data where such locations can have multiple dimensions, including a source and receiver location for each trace of input data. Such a method can returns an ordering of such data, for example, as associated with a number of tasks. As explained, a seismic processing technique (e.g., GSMP, etc.) may partition its work according to a determined order.

As an example, a method may be executed by a seismic data processor as a preparation process for a seismic data processing technique and/or a method may be run in an automated fashion as a preparation process within an initialization phase of a seismic data processing technique.

As an example, a method can involve, for each task of a technique, computing representative sparse samples from an input domain; projecting input domain samples for each task to an N-dimensional space where data locality correlates strongly with data re-use; clustering projected input domain samples to maximize locality within clusters; when a task has input domain samples fall in multiple clusters, defining a graph accordingly where nodes represent tasks and edges represent input overlap; and ordering sub-tasks based on graph, for example, to minimize travel distance.

As explained, data that are shared may be physically related. As explained, seismic energy from a source emission may be dispersed in a subsurface environment and subject to a number of reflections, which may cause portions of the seismic energy to be received by a number of different receivers. As explained, a seismic survey may be planned and organized according to a grid of positioned receivers and/or a grid to be navigated by vessels with streamer receivers. In either instance, data are acquired and stored, which may be substantial in size. As explained, seismic data may be subjected to various processing techniques, which may demand access to such data, which can cause delays in processing, energy expenditure, etc. Through an intelligent sharing approach, data accessing from a remote storage may be streamlined, for example, using localized storage resources suitable for data re-use, where possible and/or where appropriate.

As an example, a framework may include features to provide for seismic data processing work order optimization. For example, consider a framework that can determine, automatically, how to optimize data access for a technique such as a GSMP technique. In such an example, various recorded traces may be accessed and stored in memory for use and re-use. In such an approach, various recorded traces may be accessed a single time rather than multiple times, which may provide for computational efficiencies, along with other efficiencies (e.g., bandwidth, energy, etc.).

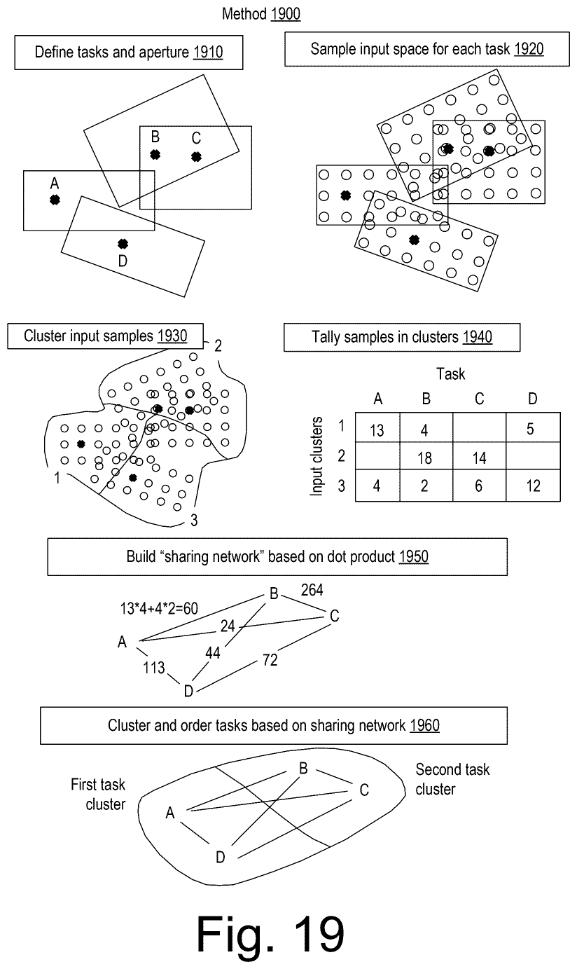

FIG. 19 shows an example of a method 1900 where examples of graphics provide for representing a scenario with a number of tasks (e.g., tasks labeled A, B, C, and D), a number of input sample clusters (e.g., labeled 1, 2, and 3) and a number of task clusters (e.g., labeled as a first task cluster and a second task cluster); noting that other scenarios may include different numbers, different arrangements, different results, etc.

As shown, the method 1900 can include a definition block 1910 for defining tasks and aperture, a sample block 1920 for sampling an input space for each of the tasks, a cluster block 1930 for clustering input samples, a tally block 1940 for tallying samples in clusters 1940 (e.g., via a data structure for input sample cluster identifier, task identifier and number of samples in each of the input sample clusters for each of the tasks), a build block 1950 for building a sharing network (e.g., based on dot products of information in a data structure), and a cluster block 1960 for clustering tasks based on the sharing network where the cluster block 1960 may also include ordering clusters of tasks such as, for example, into a first task cluster, a second task cluster, etc. In the example of FIG. 19, the first task cluster and the second task cluster may be compared with one or more of the graphics associated with one or more of the blocks 1910, 1920 and 1930. In such an example, accessing, loading, storing, etc., of data may be more efficient where tasks are performed based on task clusters.

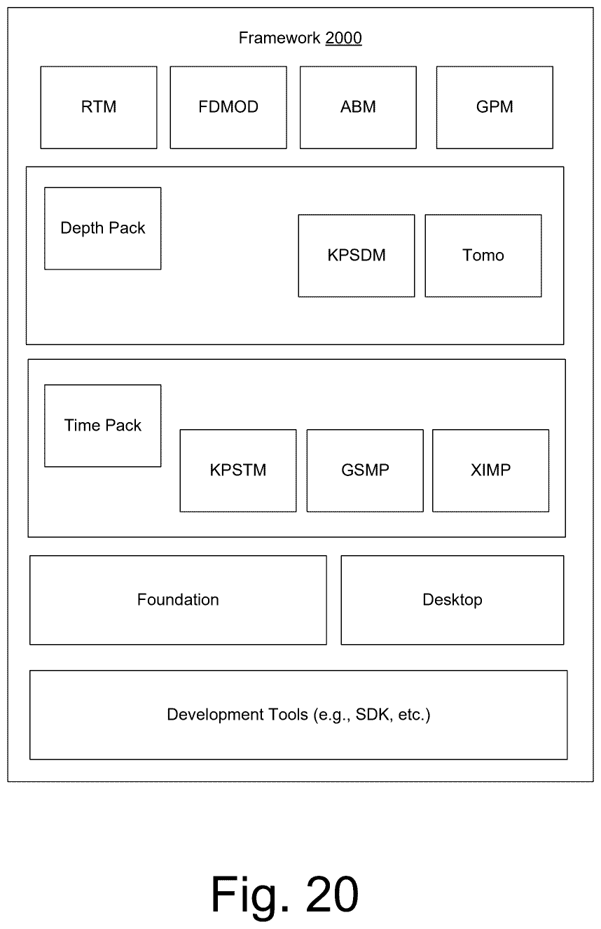

FIG. 20 shows an example of a computational framework 2000 that can include one or more processors and memory, as well as, for example, one or more interfaces. The computational framework of FIG. 20 can include one or more features of the OMEGA framework (SLB, Houston, Texas), which includes finite difference modelling (FDMOD) features for two-way wavefield extrapolation modelling, generating synthetic shot gathers with and without multiples. The FDMOD features can generate synthetic shot gathers by using full 3D, two-way wavefield extrapolation modelling, which can utilize wavefield extrapolation logic matches that are used by reverse-time migration (RTM). A model may be specified on a dense 3D grid as velocity and optionally as anisotropy, dip, and variable density.

As shown in FIG. 20, the computational framework 2000 includes features for RTM, FDMOD, adaptive beam migration (ABM), Gaussian packet migration (GPM), depth processing (e.g., Kirchhoff prestack depth migration (KPSDM), tomography (Tomo)), time processing (e.g., Kirchhoff prestack time migration (KPSTM), general surface multiple prediction (GSMP), extended interbed multiple prediction (XIMP)), framework foundation features, desktop features (e.g., GUIs, etc.), and development tools. As an example, the computational framework may provide for performing one or more types of inversions. For example, consider a full waveform inversion (FWI), which may provide for generation of a formation model (e.g., velocity model, etc.) from seismic data.

As an example, the computational framework 2000 can include one or more features for ordering of a number of tasks to be performed by one or more techniques. For example, the computational framework 2000 can include features to perform a method such as, for example, one or more method described herein, etc.

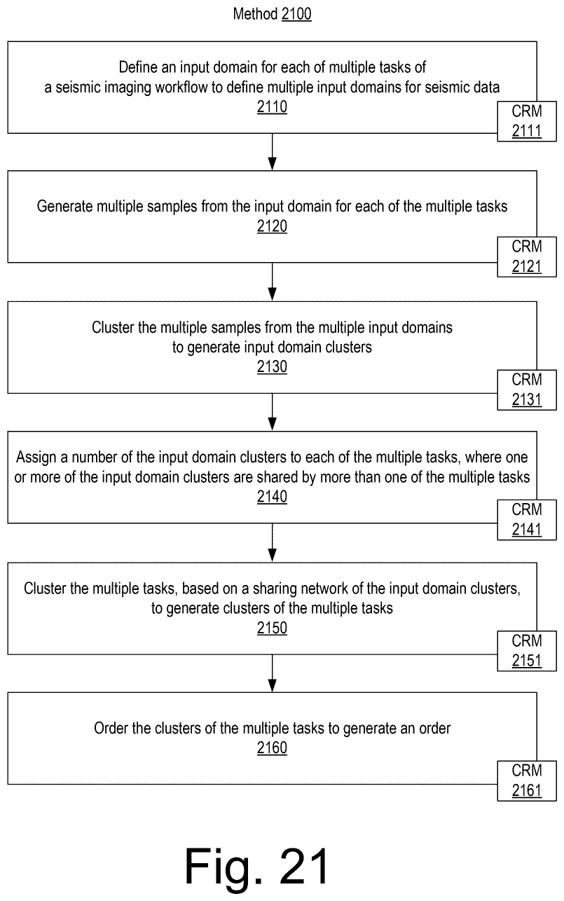

FIG. 21 shows an example of a method 2100 that can include a definition block 2110 for defining an input domain for each of multiple tasks of a seismic imaging workflow to define multiple input domains for seismic data; a generation block 2120 for generating multiple samples from the input domain for each of the multiple tasks; a cluster block 2130 for clustering the multiple samples from the multiple input domains to generate input domain clusters; an assignment block 2140 for assigning a number of the input domain clusters to each of the multiple tasks, where one or more of the input domain clusters are shared by more than one of the multiple tasks; a cluster block 2150 for clustering the multiple tasks, based on a sharing network of the input domain clusters, to generate clusters of the multiple tasks; and an order block 2160 for ordering the clusters of the multiple tasks to generate an order.

The method 2100 is shown in FIG. 21 in association with various computer-readable media (CRM) blocks 2111, 2121, 2131, 2141, 2151, and 2161. Such blocks generally include instructions suitable for execution by one or more processors (or cores) to instruct a computing device or system to perform one or more actions. While various blocks are shown, a single medium may be configured with instructions to allow for, at least in part, performance of various actions of the method 2100. As an example, a CRM block can be a computer-readable storage medium that is non-transitory, not a carrier wave and not a signal. As an example, such blocks can include instructions that can be stored in memory and can be executable by one or more of processors.

As an example, a method such as the method 1900 of FIG. 19, the method 2100 of FIG. 21, etc., may be implemented as part of a framework such as the OMEGA framework, the PETREL framework, etc. As an example, the method 1900 of FIG. 19, the method 2100 of FIG. 21, etc., may be implemented using the DELFI environment.

As an example, a system may be at least in part cloud-based. For example, a cloud platform may include compute tools, management tools, networking tools, storage and database tools, large data tools, identity and security tools, and machine learning tools. As an example, a cloud platform can include identity and security tools that can provide a key management service (KMS) tool. Key management can provide for management of cryptographic keys in a cryptosystem, which can include task associated with the generation, exchange, storage, use, crypto-shredding (destruction) and replacement of keys. It can include cryptographic protocol design, key servers, user procedures, and other relevant protocols. As an example, a system may include features of one or more cloud platforms (e.g., GOOGLE CLOUD, AMAZON WEB SERVICES CLOUD, AZURE CLOUD, etc.). As an example, the DELFI cognitive exploration and production (E&P) environment may be implemented at least in part in a cloud platform.

As an example, a cloud platform may provide for object storage, block storage, file storage (e.g., a shared filesystem), managed SQL databases, NoSQL databases, etc. As to types of data, consider one or more of text, images, pictures, videos, audio, objects, blobs, structured data, unstructured data, low latency data, high-throughput data, time series data, semi-structured application data, hierarchical data, durable key-value data, etc.

As an example, a method can include defining an input domain for each of multiple tasks of a seismic imaging workflow to define multiple input domains for seismic data; generating multiple samples from the input domain for each of the multiple tasks; clustering the multiple samples from the multiple input domains to generate input domain clusters; assigning a number of the input domain clusters to each of the multiple tasks, where one or more of the input domain clusters are shared by more than one of the multiple tasks; clustering the multiple tasks, based on a sharing network of the input domain clusters, to generate clusters of the multiple tasks; and ordering the clusters of the multiple tasks to generate an order. In such an example, the method may include performing the multiple tasks according to the order.

As an example, a method may include projecting multiple samples into an N-dimensional space where, for example, the N-dimensional space accounts for spatial characteristics of seismic data.

As an example, multiple tasks may be performed using computational nodes in a cloud platform computing environment.

As an example, an order generated by a method may reduce loading demands for loading of seismic data for performing a seismic imaging workflow. In such an example, a seismic imaging workflow may be performed in less time, with lesser resources, and/or with one or more additional procedures (e.g., quality control, interpretation, attribute generation, etc.), for example, within the same amount of time or optionally less than without generation and utilization of an order.

As an example, multiple tasks may include seismic data related tasks. For example, consider one or more tasks that may be performed using one or more features of a framework (e.g., consider the OMEGA framework, etc.).

As an example, multiple tasks may include one or more tasks for predicting multiples representative of multiple reflections of seismic energy in a subsurface region.

As an example, each of a number of multiple tasks may be associated with a source and a receiver pair and an aperture.

As an example, each of a number of multiple tasks may predict multiples for a corresponding source and receiver pair using at least a portion of seismic data.

As an example, a method may include ordering that includes implementing an optimization process. In such an example, the optimization process may optimize an order for task clusters where, for example, a workflow with tasks may be performed according to the order.

As an example, each of a number of clusters of tasks may correspond to at least one of task. As shown in the example of FIG. 19, a cluster, which may be a task cluster, can include at least one of the tasks labeled A, B, C, and D. In the example of FIG. 19, given the four tasks (e.g., as an example of multiple tasks), each of the task clusters, for the given scenario, includes two of the four tasks.

As an example, an input domain may include a surface region and locations of at least one source and a plurality of receivers of a seismic survey.

As an example, multiple tasks may be performed to determine one or more characteristics of a subsurface region. For example, one or more characteristics may depend on acoustic properties of the subsurface region.

As an example, multiple tasks may be performed to predict multiples where, for example, a method may further include, utilizing the predicted multiples, attenuating multiples in seismic data. In such an example, the attenuating may include performing adaptive subtraction. As an example, a method may include, based on attenuating multiples in seismic data, identifying one or more locations of hydrocarbons in a subsurface region. For example, consider generating one or more seismic images where, due to attenuating multiples, structural and/or fluid features of a subsurface region may be more accurately discerned such that identification of one or more locations of hydrocarbons in a subsurface region is improved. As planning, development, production, etc., of hydrocarbons from a subsurface reservoir can be a resource intensive process that may be fraught with various types of risks, an ability to more accurate discern a location or locations of hydrocarbons can be quite beneficial.

While hydrocarbons are mentioned, as an example, seismic imaging may be performed for one or more purposes related to water, CO2, etc. For example, consider seismic imaging of an aquifer, seismic imaging of a reservoir that has been substantially depleted (e.g., of hydrocarbons, water, etc.), seismic imaging of a reservoir to determine suitability for carbon capture and storage (CCS), etc.

As an example, a system may include a processor; memory operatively coupled to the processor; and processor-executable instructions stored in the memory to instruct the system to: define an input domain for each of multiple tasks of a seismic imaging workflow to define multiple input domains for seismic data; generate multiple samples from the input domain for each of the multiple tasks; cluster the multiple samples from the multiple input domains to generate input domain clusters; assign a number of the input domain clusters to each of the multiple tasks, where one or more of the input domain clusters are shared by more than one of the multiple tasks; cluster the multiple tasks, based on a sharing network of the input domain clusters, to generate clusters of the multiple tasks; and order the clusters of the multiple tasks to generate an order.

As an example, one or more computer-readable storage media can include processor-executable instructions to instruct a computing system to: define an input domain for each of multiple tasks of a seismic imaging workflow to define multiple input domains for seismic data; generate multiple samples from the input domain for each of the multiple tasks; cluster the multiple samples from the multiple input domains to generate input domain clusters; assign a number of the input domain clusters to each of the multiple tasks, where one or more of the input domain clusters are shared by more than one of the multiple tasks; cluster the multiple tasks, based on a sharing network of the input domain clusters, to generate clusters of the multiple tasks; and order the clusters of the multiple tasks to generate an order.

As an example, a computer program product can include computer-executable instructions to instruct a computing system to perform one or more methods such as, for example, one or more of the methods of FIG. 7, FIG. 10, FIG. 11, . . . , FIG. 19, FIG. 21, etc.

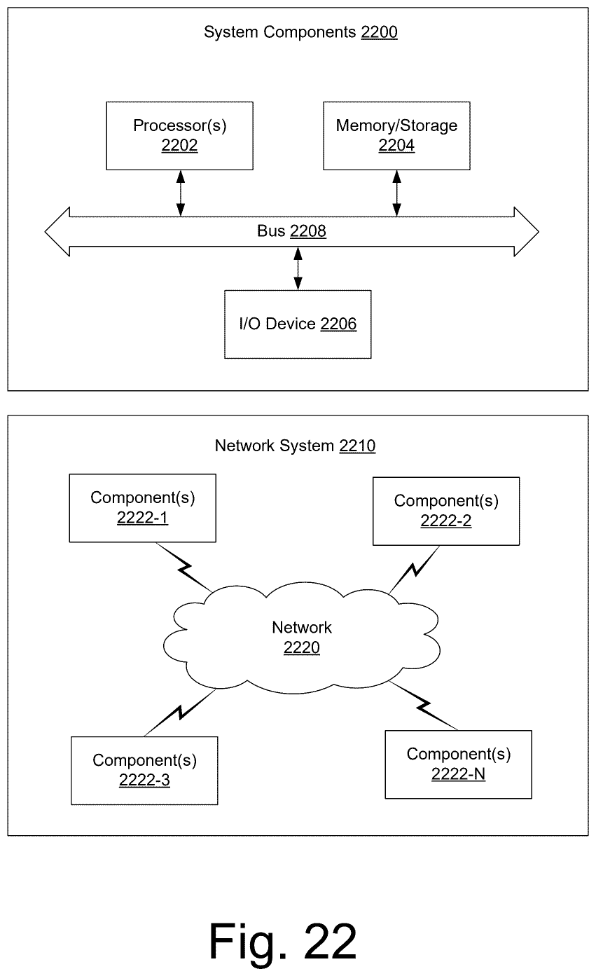

FIG. 22 shows components of an example of a computing system 2200 and an example of a networked system 2210 that includes a network 2220, which may be utilized to perform a method, to form a specialized system, etc. The system 2200 includes one or more processors 2202, memory and/or storage components 2204, one or more input and/or output devices 2206 and a bus 2208. In an example embodiment, instructions may be stored in one or more computer-readable media (e.g., memory/storage components 2204). Such instructions may be read by one or more processors (e.g., the processor(s) 2202) via a communication bus (e.g., the bus 2208), which may be wired or wireless. The one or more processors may execute such instructions to implement (wholly or in part) one or more attributes (e.g., as part of a method). A user may view output from and interact with a process via an I/O device (e.g., the device 2206). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 2210 that includes a network 2220. The network system 2210 includes components 2222-1, 2222-2, 2222-3, . . . 2222-N. For example, the components 2222-1 may include the processor(s) 2202 while the component(s) 2222-3 may include memory accessible by the processor(s) 2202. Further, the component(s) 2202-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
defining an input domain for each of multiple tasks of a seismic imaging workflow to define multiple input domains for seismic data;
generating multiple samples from the input domain for each of the multiple tasks;
clustering the multiple samples from the multiple input domains to generate input domain clusters;
assigning a number of the input domain clusters to each of the multiple tasks, wherein one or more of the input domain clusters are shared by more than one of the multiple tasks;
clustering the multiple tasks, based on a sharing network of the input domain clusters, to generate clusters of the multiple tasks; and
ordering the clusters of the multiple tasks to generate an order.

2. The method of claim 1, comprising performing the multiple tasks according to the order.

3. The method of claim 1, comprising projecting the multiple samples into an N-dimensional space.

4. The method of claim 3, wherein the N-dimensional space accounts for spatial characteristics of the seismic data.

5. The method of claim 1, wherein the multiple tasks are performed using computational nodes in a cloud platform computing environment.

6. The method of claim 1, wherein the order reduces loading demands for loading of the seismic data for performing the seismic imaging workflow.

7. The method of claim 1, wherein the multiple tasks include seismic data related tasks.

8. The method of claim 1, wherein the multiple tasks include predicting multiples representative of multiple reflections of seismic energy in a subsurface region.

9. The method of claim 1, wherein each of the multiple tasks is associated with a source and a receiver pair and an aperture.

10. The method of claim 1, wherein each of the multiple tasks predicts multiples for a corresponding source and receiver pair using at least a portion of the seismic data.

11. The method of claim 1, wherein the ordering includes implementing an optimization process.

12. The method of claim 1, wherein each of the clusters of the multiple tasks corresponds to at least one of the multiple tasks.

13. The method of claim 1, wherein the input domain includes a surface region and locations of at least one source and a plurality of receivers of a seismic survey.

14. The method of claim 1, wherein the multiple tasks determine one or more characteristics of a subsurface region.

15. The method of claim 14, wherein the one or more characteristics depend on acoustic properties of the subsurface region.

16. The method of claim 1, wherein the multiple tasks predict multiples and including, utilizing the predicted multiples, attenuating multiples in the seismic data.

17. The method of claim 16, wherein the attenuating includes adaptive subtraction.

18. The method of claim 17, comprising, based on the attenuating multiples in the seismic data, identifying one or more locations of hydrocarbons in a subsurface region.

19. A system comprising:
a processor;
memory operatively coupled to the processor; and
processor-executable instructions stored in the memory to instruct the system to:
define an input domain for each of multiple tasks of a seismic imaging workflow to define multiple input domains for seismic data;
generate multiple samples from the input domain for each of the multiple tasks;
cluster the multiple samples from the multiple input domains to generate input domain clusters;
assign a number of the input domain clusters to each of the multiple tasks, wherein one or more of the input domain clusters are shared by more than one of the multiple tasks;
cluster the multiple tasks, based on a sharing network of the input domain clusters, to generate clusters of the multiple tasks; and
order the clusters of the multiple tasks to generate an order.

20. One or more computer-readable storage media comprising processor-executable instructions to instruct a computing system to:
define an input domain for each of multiple tasks of a seismic imaging workflow to define multiple input domains for seismic data;
generate multiple samples from the input domain for each of the multiple tasks;
cluster the multiple samples from the multiple input domains to generate input domain clusters;
assign a number of the input domain clusters to each of the multiple tasks, wherein one or more of the input domain clusters are shared by more than one of the multiple tasks;
cluster the multiple tasks, based on a sharing network of the input domain clusters, to generate clusters of the multiple tasks; and
order the clusters of the multiple tasks to generate an order.
